(19) United States
(12) Patent Application Publication
(10) Pub. No.: US 2005/0060719 A1
(43) Pub. Date: Mar. 17, 2005

(54) Capturing and processing user events on a computer system for recording and playback

(75) Inventors: Scott Gray, Urbana, IL (US); Patrick Flanigan, Champaign, IL (US); Kendell Welch, Champaign, IL (US)

Correspondence Address: BANNER & WITCOFF, LTD., TEN SOUTH WACKER DRIVE, SUITE 3000, CHICAGO, IL, 60606, US

(73) Assignee: Useractive, Inc., Champaign, IL (US)

(21) Appl. No.: 10/661,266

(22) Filed: Sep. 12, 2003

(51) Int. Cl. G06F 9/00

(52) U.S. Cl. 719/318

(57) ABSTRACT

The present invention provides methods and apparatus for capturing and processing user events that are associated with screen objects on a computer system. User events may be captured and recorded so that the user events may be reproduced either at the user's computer or at another computer. An event engine is instructed, through a user interface, to capture and to process a user event that is applied to a screen object. The event engine interacts with one or more application programming interfaces that are supported by the applications being monitored. User events may be processed by an event engine so that each user event is represented as an event entry in a file. The file may be a text file such as an Extensible Markup Language (XML) file, in which each user event is represented by a plurality of attributes that describe user actions, corresponding screen object, and application.

### CROSS-REFERENCE TO RELATED APPLICATIONS

This application is related to application Ser. No. ______, attorney docket number 6030.00003, entitled “DISTANCE-LEARNING SYSTEM WITH DYNAMICALLY CONSTRUCTED MENU THAT INCLUDES EMBEDDED APPLICATIONS,” which is incorporated herein by reference and which was filed concurrently with this application.

### FIELD OF THE INVENTION

The present invention relates to capturing and processing user events on a computer system. User events may be recorded, edited, and played back for subsequent analysis.

### BACKGROUND OF THE INVENTION

With the proliferation of computer systems and different program applications, computer users are becoming more dependent on assistance for training the user about the different applications. The user may require assistance for different user scenarios, including computer set-up, application training, application evaluation and help desk interaction. For example, the user may require training for an application, e.g. Microsoft Word, where a training assistant monitors the user actions from a remote site. However, in order to enhance the efficiency of a training staff, a training assistant may support the training for other applications. Thus, the training assistant may also support another user with a different application, e.g. Intuit Quicken, either during the same time period or a different time period.

In supporting a user in the different user scenarios, user actions may be monitored and analyzed by support staff. A user action is typically an action entered through an input device such as pointer device or a keyboard and includes mouse clicks and keystrokes. Typically, each specific application requires a different solution by a support system in order to capture and process user actions. Additionally, updating the support system magnifies the effort, increasing the cost, increasing the difficulty to use the support system, and decreasing the efficiency of the support system. For example, if an application utilizes macros to support the capturing of user actions, the macros may require modifications with each new version of the application.

It would be an improvement in the field of software applications support to provide methods and apparatuses that provide a consistent approach and that use highly ubiquitous technologies, thus reducing the need to tailor and maintain different solutions for different applications.

### BRIEF SUMMARY OF THE INVENTION

The present invention provides methods and apparatus for capturing and processing user events that are associated with screen objects that appear on a computer display device. User events may be captured and recorded so that the user events may be reproduced either at the user's computer or at another computer, which may be remotely located from the user's computer.

With an aspect of the invention, an event engine is instructed, through a user interface, to capture and to process a user event that is applied to a screen object. The screen object corresponds to an application that is executing on the user's computer. The user event may be one of a series of user events applied to one or more screen objects. Different commands may be entered through the user interface, including commands to record, store, retrieve, and reproduce user events.

With an aspect of the invention, an event engine interacts with one or more application programming interfaces (APIs) that may be supported by the applications being monitored. With an embodiment, the event engine supports an Active Accessibility® API to capture user events that are associated with a user's mouse and a Windows® system hooks to capture user events that are associated with a user's keyboard.

With another aspect of the invention, user events are processed by an event engine so that each user event is represented as an event entry in a file. The file may be a text file such as an Extensible Markup Language (XML) file, in which each user event is represented by a plurality of attributes that describe the corresponding user action, screen object, and application.

With another aspect of the invention, a user interface supports a plurality of commands through a window that is displayed at the user's computer. The command types include recording user events, saving a file representing the user events, loading the file, playing back the file to reproduce the user events, viewing the file, and adding notes to the file. Also, the user interface may support a recording speed that adjusts the speed of capturing user events in accordance with the user's operating characteristics.

With another aspect of the invention, user events, which are occurring on a user's computer, are captured and processed at a remote computer. The user's computer interacts with an event engine that is executing on the remote computer through a toolbar using Microsoft Terminal Services. Moreover, remote operation enables an expert (e.g., a helpdesk) to view a series of actions performed by a user at a remote computer while the user is using an application. The expert may record and playback the series of actions for asynchronous use and analysis. Additionally, remote operation enables the expert to teach the user how to use the application by showing a correct sequencing of actions to the user.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows an exemplary screenshot of capturing user events in accordance with an embodiment of the invention;

FIG. 2 shows an exemplary architecture for capturing and processing user events in accordance with an embodiment of the invention;

FIG. 3 shows screenshot of a user interface in accordance with an embodiment of the invention;

FIG. 4 shows a flow diagram for capturing and processing user events in accordance with an embodiment of the invention;

FIG. 5 shows a flow diagram for capturing and processing user events in responding to a recording command in accordance with an embodiment of the invention;

FIG. 6 shows a flow diagram for playing back an event file in accordance with an embodiment of the invention;

FIG. 7 shows a flow diagram for including notes in an event file in accordance with an embodiment of the invention; and

FIG. 8 shows an exemplary XML file corresponding to captured user events in accordance with an embodiment of the invention.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

Definitions for the following terms are included to facilitate an understanding of the detailed description.
Active Accessibility®—A Microsoft initiative, introduced in 1997, that consists of program files and conventions that make it easier for software developers to integrate accessibility aids, such as screen magnifiers or text-to-voice converters, into their application's user interface to make software easier for users with limited physical abilities to use. Active Accessibility is based on COM technologies and is supported by Windows 95 and 98, Windows NT 4.0, Internet Explorer 3.0 and above, Office 2000, and Windows 2000.
ActiveX®—a set of technologies that enables software components to interact with one another in a networked environment, regardless of the language in which the components were created. ActiveX, which was developed as a proposed standard by Microsoft in the mid 1990s and is currently administered by the Open Group, is built on Microsoft's Component Object Model (COM). Currently, ActiveX is used primarily to develop interactive content for the World Wide Web, although it can be used in desktop applications and other programs. ActiveX controls can be embedded in Web pages to produce animation and other multimedia effects, interactive objects, and sophisticated applications.
ActiveX controls—reusable software components that incorporate ActiveX technology. These components can be used to add specialized functionality, such as animation or pop-up menus, to Web pages, desktop applications, and software development tools. ActiveX controls can be written in a variety of programming languages, including C, C++, Visual Basic, and Java.
Application programming interface (API)—a set of functions and values used by one program (e.g., an application) to communicate with another program or with an operating system.
Component Object Model (COM)—a specification developed by Microsoft for building software components that can be assembled into programs or add functionality to existing programs running on Microsoft Windows platforms. COM components can be written in a variety of languages, although most are written in C++, and can be unplugged from a program at run time without having to recompile the program. COM is the foundation of the OLE (object linking and embedding), ActiveX, and DirectX specifications.
Desktop—an on-screen work area that uses icons and menus to simulate the top of a desk. A desktop is characteristic of the Apple Macintosh and of windowing programs such as Microsoft® Windows®. Its intent is to make a computer easier to use by enabling users to move pictures of objects and to start and stop tasks in much the same way as they would if they were working on a physical desktop.
Dynamic Link Library (DLL)—a library of executable functions or data that can be used by a Windows® application. Typically, a DLL provides one or more particular functions and a program accesses the functions by creating either a static or dynamic link to the DLL. A static link remains constant during program execution while a dynamic link is created by the program as needed. DLLs may also contain just data.
Extensible Markup Language (XML)—used to create new markups that provide a file format and data structure for representing data on the web. XML allows developers to describe and deliver rich, structured data in a consistent way.
Instantiate—producing a particular object from its class template
Screen Objects—individual discrete elements within a graphical user-interface environment having a defined functionality. Examples would include buttons, drop-down lists, links on a web page, etc.
Win32® API—application programming interface in Windows 95 and Windows NT that enables applications to use the 32-bit instructions available on 80386 and higher processors. Although Windows 95 and Windows NT support 16-bit 80×86 instructions as well, Win32 offers greatly improved performance.
Windows® system hooks provide a mechanism to intercept messages before they reach their target window.

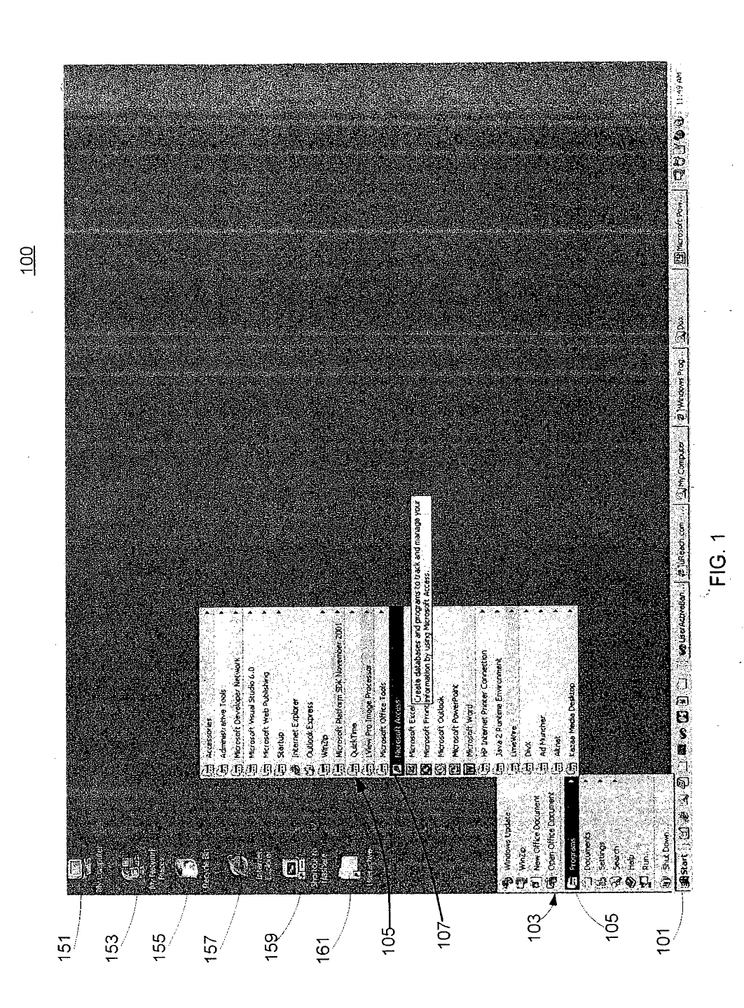

FIG. 1 shows an exemplary screenshot 100 of capturing user actions in accordance with an embodiment of the invention. In screenshot 100, a user positions and clicks the user's mouse on a “Start” push button 101, positions and clicks the mouse on a “Programs” menu entry 105 from a start menu 103, and then positions and clicks a “Microsoft Access” menu entry 107 from a programs menu 105 in order to launch the Microsoft Access application. In the example shown in FIG. 1, the user is acting on selections from the desktop. Additionally, screen objects 151-161 appear on the desktop. In the example, if a screen object (corresponding to a shortcut) were created for Microsoft Access, the user could alternatively launch the Microsoft Access application by double-clicking on the associated screen object.

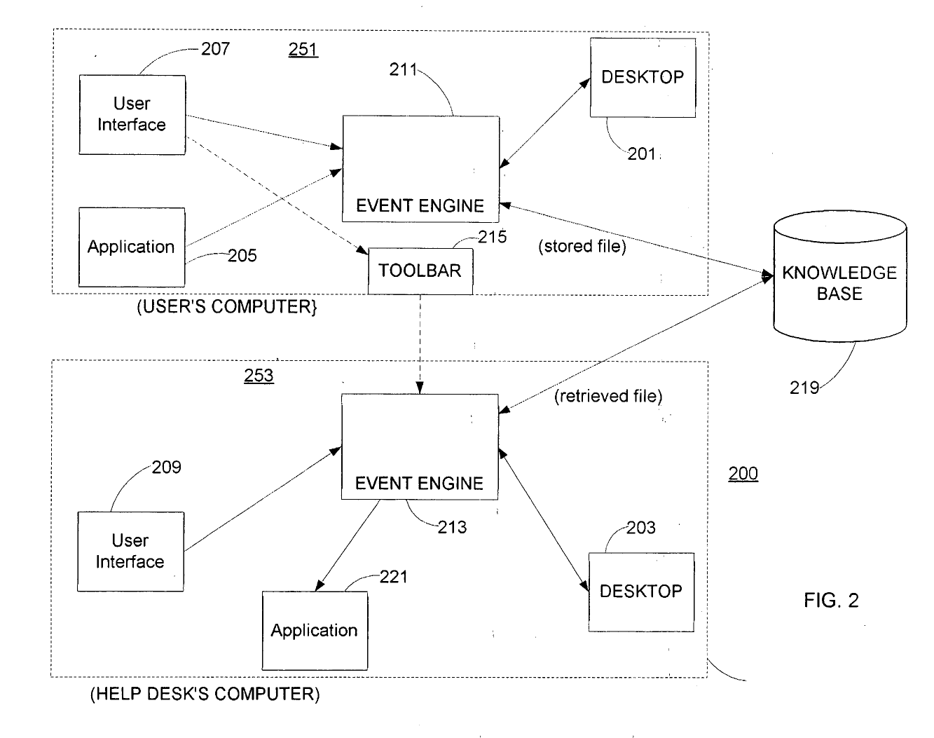

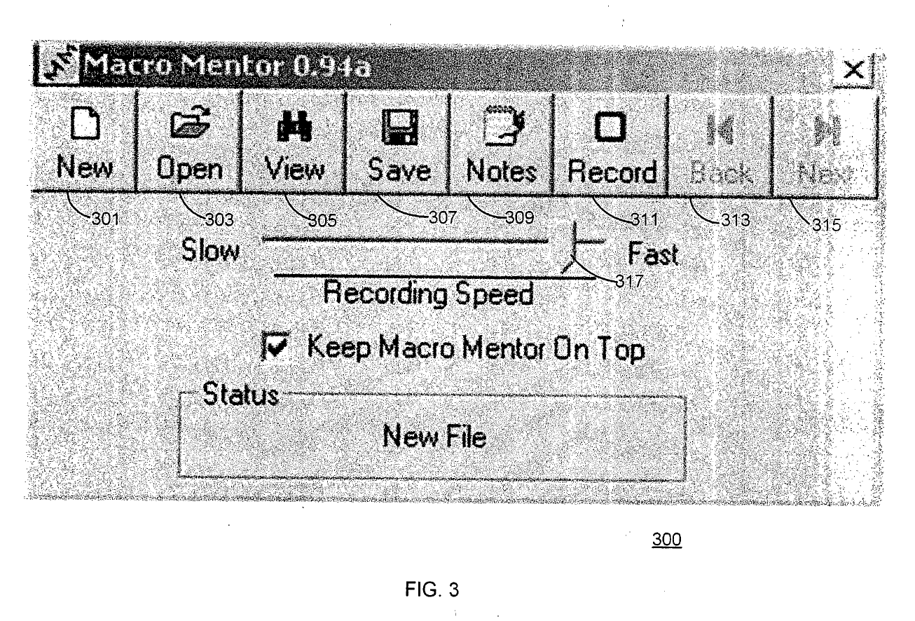

FIG. 2 shows an exemplary architecture 200 for capturing and processing user events (e.g., a user event corresponding to clicking on menu 105 as shown in FIG. 1) in accordance with an embodiment of the invention. FIG. 2 shows an exemplary computer system, comprising a user's computer 251 and a help desk's computer 253. In the example, shown in FIG. 2, a user is manipulating a mouse and a keyboard to generate user events that are associated with an application 205. In the embodiment, application 205 is a software program, including a database manager, spreadsheet, communications package, graphics package, word processor, and web browser. The user is operating on desktop 201. For example, the user may click or double-click on a screen object (associated with application 205) or may enter text into a window corresponding to application 205. The user may activate the capturing and processing of user events by entering commands through a user interface 207 such as entering a record command. (User interface 207 is discussed in more detail with FIG. 3.) An event engine component 211 receives commands from User Interface so that event engine 211 is configured to capture and process user events. In the embodiment, event engine 211 is implemented as an ActiveX component that may be accessed by a Win32 application as well as by a web page using Javascript or a Win32 Visual Basic component. (Event engine 211 is a dynamic link library (DLL). In the embodiment, event engine 211 is implemented as an ActiveX component, although other embodiments of the invention may implement event engine 211 with other software tools and computer languages, e.g., Java.) Typical user events include mouse clicks and keystrokes.

In the embodiment, event engine 211 uses a Microsoft Active Accessibility application programming interface (API) to determine desktop objects that have been acted upon by the user. The Active Accessibility API is coordinate-independent of the screen object so that much of the screen and position data is not required for processing the user event by event engine 211. The Active Accessibility API is extensively supported by Microsoft Win32 applications, and event engine 211 uses the Active Accessibility API to capture user events such as mouse clicks on a screen object. For example, event engine 211 can capture a user event scenario associated with the Microsoft Word application, e.g., highlighting a text string, clicking on “edit” in the toolbar, and then clicking on the “paste entry” on the edit menu. Also, the embodiment uses Window system hooks, which supports another API, to capture other types of user events e.g., keystrokes, thus supporting the storage of user events with reduced overhead.

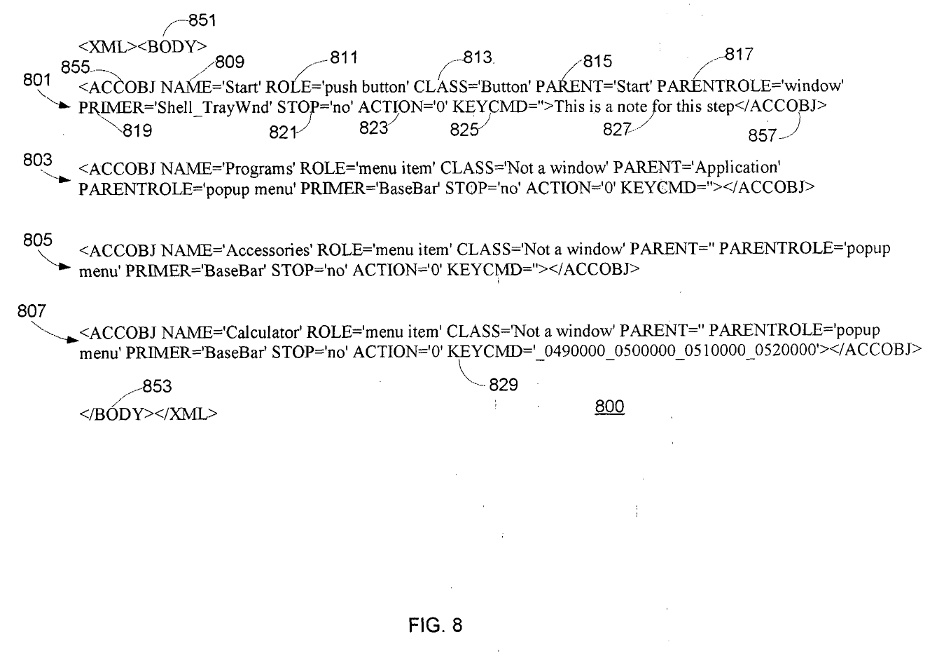

Event engine 211 captures a user event that is associated with application 205 by utilizing the Active Accessibility API and the Windows system hooks API. Event engine 211 processes a captured user event so that the user event is represented as an event entry. The data entry may be included in a file that may be stored in a knowledge base 219 for subsequent access by computer 251 or by computer 253 in order to process the stored file. User events are stored as event entries, e.g. an event entry 801 of an XML file 800 as shown in FIG. 8.

In exemplary architecture 200, help desk computer 253 supports a user interface 209 and event engine 213. For example, an operator of computer 253 may be assisting the user of computer 251 with using application 205. In order to do so, the operator of computer 253 may access the stored file from knowledge base 219 and playback the file, thus reproducing the user events for application 221 that corresponds to application 205. The operator of computer 253 is consequently able to view the sequencing of the user events in the context of application 221. For example, with a file corresponding to screenshot 100, the operator of help desk computer 253 is able to see the sequencing of menu selections as shown in FIG. 1. Consequently, the operator of computer 253 may provide comments to the user of computer 251 about using application 205.

Although the example shown in FIG. 1 shows event engine 211 operating on screen objects at the desktop, event engine 211 can capture user events for applications (corresponding to screen objects) located at a different level, e.g., \C:directory_name\subdirectory_name.

In architecture 200, as shown in FIG. 2, computer 251 and computer 253 may be physically the same computer. Also, architecture 200 supports computer configurations in which computer 251 and computer 253 are not the same physical computer. Moreover computer 253 may be remotely located to computer 251. In such a case, the user may be generating user events on computer 251, while event engine 213 (rather than event engine 211) executes on computer 253 to capture the user events on computer 251. Application 205 interacts with a toolbar 215 using Microsoft Terminal Services so that event engine 213 is able to capture user events using the Active Accessibility API and Windows system hooks. In the embodiment, toolbar 215 is implemented as a client-server application and is disclosed in a co-pending patent application entitled “DISTANCE-LEARNING SYSTEM WITH DYNAMICALLY CONSTRUCTED MENU THAT INCLUDES EMBEDDED APPLICATIONS”, having Attorney docket no. 6030.00003, filed concurrently with this application, wherein the co-pending patent application is incorporated by reference in its entirety.

FIG. 3 shows a screenshot 300 of user interface 207 in accordance with an embodiment of the invention. User interface 207 supports a plurality of command types, including a “new” command 301, an “open” command 303, a “view” command 305, a “save” command 307, a “notes” command 309, a “record” command 311, a “back” command 313, and a “next” command 315. “New” command 301 resets the memory of event engine 211 or 213 and initializes states for a new recording. “Open” command 303 prompts the user for the name of an existing file and loads it. “View” command 305 allows the user to view the XML of the currently loaded file. (In the embodiment, the file is compliant with XML, although other file formats may be used.) “Save” command 307 prompts the user for the file name and saves the currently loaded file. “Notes” command 309 indicates to event engine 211 or 213 that the user wants to add notes to each event entry (event step). “Notes” command 309 enables an annotation to be entered and associated with the user event. (The notes capability is illustrated as notes attribute 827 as shown in FIG. 8.) “Record” command 311 starts and stops the recording process. In the embodiment, if event engine 211 is not recording user events, selecting “record” command 311 will commence recording. If event engine 211 is recording user events, selecting “record” command 311 will stop recording. “Back” command 313 playbacks the previous event entry (event step) within the currently loaded file. “Next” command 315 playbacks the next event entry within the currently loaded file. “Back” command 313 and “Next” command 315 enable a user (which may not be the same user that generated the user event) to playback a file to reproduce a series of user events that were recorded. The embodiment may support other types of commands that are not shown in screenshot 300. For example, a technician at a help desk may view (corresponding to “view” command 305) an XML file and may edit an attribute of a specific event entry in order to modify the user event to correct a user's error when the XML file is replayed. Modifying the XML file may help to illustrate proper operation of an application to the user when the file is replayed for the user.

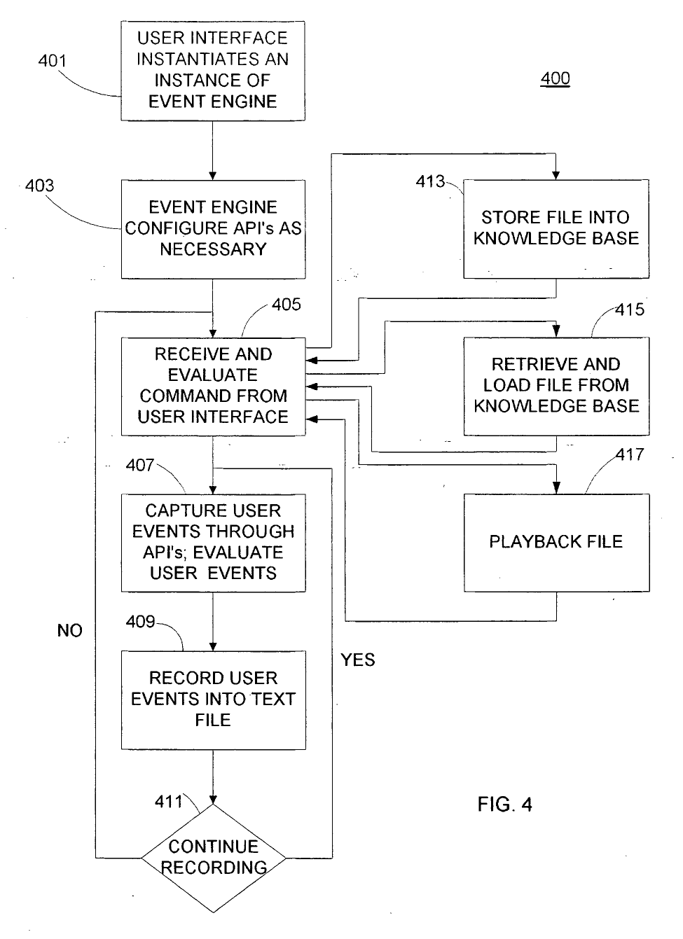

FIG. 4 shows a flow diagram 400 for capturing and processing user events in accordance with an embodiment of the invention. Flow diagram 400 demonstrates the basic operation of event engine 211, in which a user first requests that user events be recorded, be stored in a file at a knowledge base, be retrieved from the knowledge base, and be played back from the retrieved file. In step 401, user interface 207 instantiates event engine 211 (which is an instance of an event engine for capturing user events). In step 403, event engine 211 configures application programming interfaces as necessary. For example, in the embodiment event engine 211 instantiates the Window system hook library and initializes callbacks and hooks. (Windows system hooks supports an API, where a “hook” is associated with a type of user event, e.g., a “mouse click.”) In the embodiment, the Windows system hooks is used to capture keystroke user events while the Active Accessibility API is used to capture other types of user events. In step 405, event engine 211 receives and evaluates “record” command 311 from user interface 207. Event engine 211 captures user events though the Windows system hooks or the Active Accessibility API in step 407. In step 409, event engine 211 processes information from the API and forms an event entry in a file. In the embodiment, the file is implemented as an XML file 800 as shown in FIG. 8. In other embodiments, other formats of a text file may be supported. Moreover, other embodiments may support a non-text file, e.g., binary file. In step 411, event engine 211 will continue to monitor and capture user events unless instructed by the user through user interface 207 by the user entering a subsequent record command 311. (In the embodiment, record command 311 functions similar to a toggle switch that alternates states for each input occurrence.) If event engine 211 determines to continue recording, steps 405, 407, and 409 are repeated. Otherwise, process 400 returns to step 405, in which user interface 207 evaluates subsequent commands.

In flow diagram 400, the user next enters “save” command 307 through user interface 207. Consequently, step 413 is executed. In step 413, a file (that is formed from the user events and the associated information that is obtained from the APIs) is stored in knowledge base 219. However, the embodiment supports storing the file locally at computer 211, e.g., on a disk drive. Once the file is saved, step 405 is repeated, in which user interface 207 receives a subsequent command.

In flow diagram 400, the user next enters “open” command 303. Consequently, step 415 is executed. In step 415, the file is retrieved and loaded into computer 251 so that event engine 211 may process the file. Once the file is loaded, step 405 is repeated, in which user interface 207 receives a subsequent command form the user.

In flow diagram 400, the user next enters a playback command, e.g., “next” command 315. Consequently, step 417 is executed. In step 417, the next user event is reproduced as recorded in the file. The user may enter “back” command 313, in which the previous user event is reproduced. In other embodiments of the invention, the file may be automatically sequenced in which a next user event is played every predetermined duration of time.

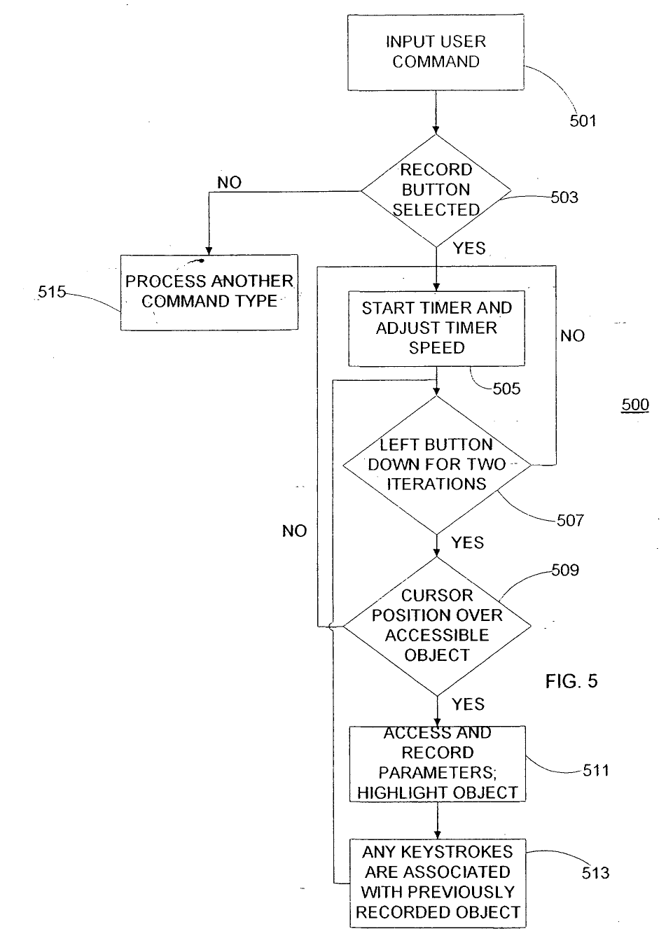

FIG. 5 shows a flow diagram 500 for capturing and processing user events in responding to “record” command 311 in accordance with an embodiment of the invention. In step 501, the user enters a command through user interface 207. If the entered command is determined to be “record” command 311 in step 503, steps 505-513 are executed. If step 503 determines that another command type has been entered, event engine 211 processes user events according to the command type in step 515. In step 505, event engine 211 starts a timer and adjusts a timer speed in accordance with recording speed input 317 (as shown in FIG. 3). In step 507, if the left mouse button is depressed for two or more clock iterations, step 509 is executed. Otherwise, step 505 is repeated. In step 509, event engine 511 determines, from the information provided by the Active Accessibility API, whether the cursor is positioned over a screen object that is supported by the Active Accessibility API. If so, step 511 is executed; otherwise, step 505 is repeated. In step 511, event engine 211 obtains parameters about the user event that is associated with the screen object. Additionally, in step 511, event engine 211 highlights the screen object that corresponds to the user event. In step 513, any keystrokes that are entered by the user are associated with the previously recorded screen object because a user event corresponding to the mouse is assumed to precede user events associated with the keyboard. In the embodiment, keystrokes are captured by event engine 211 using Windows system hooks. Step 507 is repeated in order to continue recording user events.

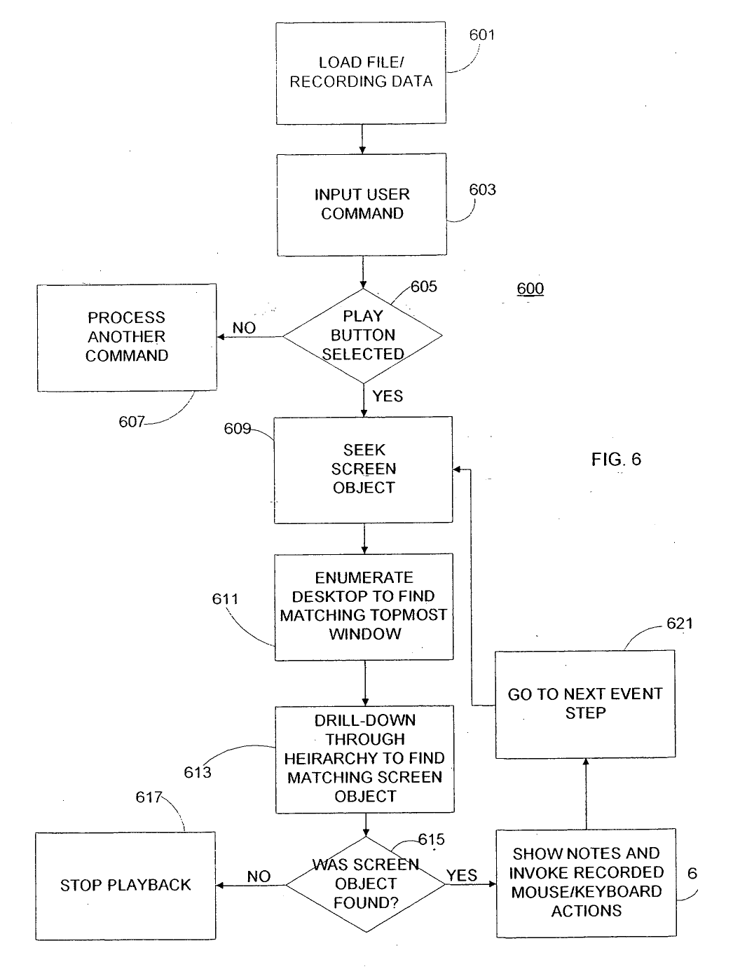

FIG. 6 shows a flow diagram 600 for playing back an event file in accordance with an embodiment of the invention. In step 601, a user enters a command (e.g., “open” command 303 that is shown in FIG. 3) to load a file (e.g. file 800 that will be discussed with FIG. 8). The file has contents that enable an event engine (e.g. event engine 211 shown in FIG. 2) to reproduce the recorded user events. In step 603, a user inputs a command through a user interface (e.g. user interface 207). If the user has entered a command to playback the file, step 609 starts to seek to find the associated screen object that is associated with the first event entry of the file. If another type of command is entered, however, step 607 is executed to process the other command type by the event engine.

From step 609, the event engine continues to process step 611, in which the event engine enumerates the desktop to find a matching topmost window that is associated with the screen object. (The topmost window is identified by an attribute of the event entry as will be discussed with FIG. 8.) In step 613, the event engine drills-down through a hierarchy of screen objects on the desktop to find the matching screen object. If the screen object is found in step 615, the event engine will show notes and invoke recorded mouse/keyboard actions in step 619 in accordance with attributes of the event entry. In step 621, the event engine processes the next event entry (event entry). However, if the screen object is not found in step 615, playback is stopped in step 617.

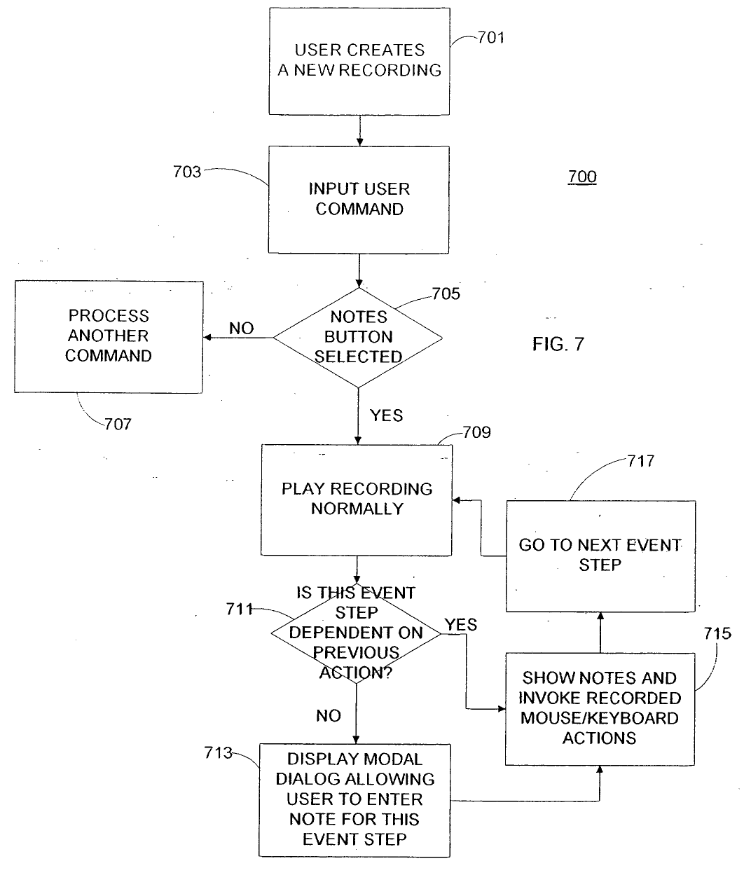

FIG. 7 shows a flow diagram 700 for including notes in an event file in accordance with an embodiment of the invention. In step 701, a user creates a new recording (e.g. corresponding to steps 407-411 of flow diagram 400 as shown in FIG. 4) of a series of user events. In step 703, a user subsequently enters a command through the user interface. If the event engine determines that the command is a notes command (corresponding to “notes” command 309 as shown in FIG. 3) in step 705, step 709 is executed so that the recording is played back. If the event engine determines that the command is another command type, step 707 is executed in accordance with the other command type.

As the recording is played by sequencing through the recorded user events, the event engine, in step 711, determines whether the currently played user event (event step) is dependent on the previously recorded user event. If not, a modal dialog is displayed, in step 713, to the user in order to allow the user to enter a note (annotation) for the currently played user event. If step 711 determines that the currently played user event is dependent on the previously recorded user event, the associated notes is displayed to the user and the recorded mouse/keyboard actions are invoked in step 715. In step 717, the event engine advances to the next recorded user event and step 709 is repeated.

FIG. 8 shows an exemplary Extensible Markup Language (XML) file 800 corresponding to captured user events in accordance with an embodiment of the invention. Other embodiments of the invention may use other formats for a text file or may support a non-text file, e.g., a binary file. XML file 800 corresponds to user events corresponding to event entries 801-807. User entries 801-807 are contained within tags 851 and 853. With the first user event (corresponding to event entry 801), a user clicks on the start button. With the second user event (corresponding to event entry 803), the user selects and clicks on “Program” from the start menu. With the third user event (corresponding to event entry 805), the user selects and clicks on “Accessories” from the programs menu. With the fourth user event (corresponding to event entry 807), the user selects and clicks on “Calculator” from the accessories menu.

XML file 800 is based on an XML schema, in which an event entry (corresponding to an element specified within the “ACCOBJ” tags, e.g., tags 855 and 857) is associated with a name attribute 809, a role attribute 811, a class attribute 813, a parent attribute 815, a parentrole attribute 817, a primer window attribute 819, a stop attribute 821, an action attribute 823, a keycmd attribute 825 and a notes attribute 827. Name attribute 809 is the name of the screen object as exposed by Active Accessibility. Role attribute 811 is the role of the screen object as exposed by Active Accessibility (e.g., push button, combo box). Class attribute 813 is the class name of the screen object as exposed by Active Accessibility. Parent attribute 815 is the name of the screen object's accessible parent object. Parentrole attribute 817 is the screen object's accessible parent as exposed by Active Accessibility (e.g., window, menu). Primer window attribute 819 is a class name of the screen object's topmost window (for identifying correct application for playback). Action attribute 823 is the mouse action-type being recorded (e.g., left-click, right-click, double-click). Keycmd attribute 825 contains the keyboard input to be associated with each event step. Keycmd attribute 825 includes key-code and any modifier keys (e.g., shift, ctrl, alt, windows key). (While keycmd attribute 825 does not contain any keyboard characters, keycmd attribute 829 that is associated with event entry 807 does contain keyboard entries.) Notes attribute 827 contains textual information that is displayed during playback and is typically used by the recorder to add comments at specific event steps.

The embodiment also supports exporting XML file 800 as a hypertext markup language (HTML) file. A web browser, e.g., Microsoft Internet Explorer, can playback the HTML file.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method for monitoring user actions on a computer system, comprising:
(a) determining, with a first application programming interface (API), whether a first screen object has been acted upon by a user, the first API being coordinate-independent and application message independent with respect to the first screen object; and
(b) in response to (a), capturing a user event associated with the first screen object.

2. The method of claim 1, further comprising:
(c) processing the captured user event.

3. The method of claim 1, wherein the first API comprises an Active Accessessibility® API.

4. The method of claim 1, further comprising:
(d) determining, with a second API, whether a second screen object has been acted upon by the user.

5. The method of claim 1, further comprising:
(d) determining, with a second API, whether the first screen object has been acted upon by the user.

6. The method of claim 2, wherein (c) comprises:
(i) representing the captured user event as an event entry in a file.

7. The method of claim 6, wherein (c) further comprises:
(ii) storing the file.

8. The method of claim 7, wherein (c) further comprises:
(iii) retrieving the file.

9. The method of claim 8, wherein (c) further comprises:
(iv) playing back the user event from the event entry of the file.

10. The method of claim 6, wherein (c) further comprises:
(ii) editing the event entry of the file.

11. The method of claim 10, wherein (ii) comprises:
(1) modifying the event entry to represent a modified user event.

12. The method of claim 6, wherein the file comprises a text file.

13. The method of claim 7, wherein the text file complies with an Extensible Markup Language (XML) format.

14. The method of claim 2, further comprising:
(d) inputting a command, through a user interface, that is indicative of subsequent processing of the user event.

15. The method of claim 14, wherein the command is indicative of recording the user event, wherein (c) comprises:
(i) determining a speed associated with the user event;
(ii) determining whether a cursor is positioned over the first screen object; and
(iii) if the cursor is over the first object, accessing and recording parameters associated with the first screen object.

16. The method claim 15, wherein (c) further comprises:
(iv) highlighting the first screen object.

17. The method of claim 15, wherein (c) further comprises:
(iv) if a keystroke is entered, associating the keystroke with a previously recorded object.

18. The method of claim 7, wherein (ii) comprises:
(1) creating a knowledge base for archiving and exchanging at least one file, wherein each file comprises a representation of a set of user events.

19. The method of claim 18, wherein (ii) further comprises:
(2) maintaining the knowledge base in accordance with at least one subsequent user event.

20. The method of claim 1, wherein the first API is selected from the group consisting of an Access Accessibility® API, a Win32® API, and a Windows® system hooks API.

21. The method of claim 1, wherein the first screen object is associated with an application program.

22. The method of claim 21, wherein the first screen object comprises a desktop object.

23. The method if claim 1, wherein the first screen object is associated with a web page.

24. The method of claim 1, wherein the user event occurs on a first computer of the computer system and wherein the user event is captured on the first computer.

25. The method of claim 1, wherein the user event occurs on a first computer of the computer system and wherein the user event is captured on a second computer of the computer system.

26. The method of claim 25, wherein an application or web page interacts with a remote software component through a toolbar in conjunction with a terminal service client.

27. The method of claim 13, wherein the XML file is exported as a hyper text markup language (HTML) file, wherein a web browser is utilized to playback the HTML file.

28. The method of claim 14, wherein the command is selected from the group consisting of a new command, an open command, a view command, a save command, a notes command, a record command, a back command, and a next command.

29. The method of claim 14, wherein the command is indicative of playing back the user event, wherein (d) comprises:
(i) reading the event entry from a text file; and
(ii) reproducing the user event from the determining whether a cursor is positioned over the first screen object.

30. The method of claim 14, wherein the command is indicative of playing back a file, wherein (c) comprises:
(i) enumerating a desktop;
(ii) in response to (i), drilling down through a hierarchy to find a matching screen object in accordance with at least one attribute of the event entry; and
(iii) if the matching screen object is not found, stopping playback of the file; and
(iv) if the matching screen object is found, invoking a recorded action that is associated with the user event.

31. The method of claim 30, further comprising:
(v) in response to (iv), proceeding to a next user event that is recorded by the file.

32. The method of claim 12, wherein the event entry comprises a notes attribute, the notes attribute providing an annotation about the user event.

33. The method of claim 1, wherein (b) is performed by an ActiveX® component.

34. The method of claim 2, wherein (C) is performed by an ActiveX® component.

35. The method of claim 6, wherein the event entry comprises a text entry.

36. A computer-readable medium having computer-executable instructions for performing the method as recited in claim 1.

37. A computer-readable medium having computer-executable instructions for performing the method as recited in claim 2.

38. A computer-readable medium having computer-executable instructions for performing:
(a) a processing module that captures and processes a user event by utilizing an application programming interface (API), wherein the user event is associated with a screen object and wherein the API is coordinate-independent and application message independent with respect to the screen object; and
(b) a data storage module that converts the user event to an event entry in a file.

39. The computer-readable medium of clam 38, further comprising:
(c) an input user interface module that receives a command and notifies the processing module about the command, the command being indicative about subsequent capturing and processing of the user event by the processing module.

40. A computer-readable medium having stored thereon a data structure, comprising:
(a) a first data field that identifies an object name of a screen object that is associated with a user event;
(b) a second data field that identifies an object role of the screen object:
(c) a third data field that identifies an object class name of the screen object;
(d) a fourth data field that identifies a parent name, the parent name being associated with a parent of the screen object;
(e) a fifth data field that identifies a parent role, the parent role being associated with the parent of the screen object;
(f) a sixth data field that identifies a primer window, the primer window being a window class name being associated with a topmost window of the screen object;
(g) a seventh data field that identifies an action type, the action type being associated with a mouse action that is being recorded; and
(h) an eighth data field that identifies a keyboard input that is associated with the user event.

41. A computer-readable medium having stored thereon a data structure of claim 40, further comprising:
(i) a ninth data field that identifies textual information to be displayed during playback of the data structure.

42. A method for monitoring user actions on a computer system, comprising:
(a) inputting a command that is indicative of subsequent processing of the user event.
(b) in response to (a), determining, with an application programming interface (API), whether a screen object has been acted upon by a user, the API being coordinate-independent and application message independent with respect to the screen object;
(c) in response to (a), capturing a user event associated with the screen object;
(d) representing the captured user event as an event entry in a text file;
(e) subsequently retrieving the text file; and
(f) playing back the user event from the event entry of the text file, wherein the user event is reproduced on an output device.

43. A method of claim 1, further comprising:
(c) determining, with the first API, whether another screen object has been acted upon by the user, the first API being coordinate-independent and application message independent with respect to the other screen object; and
(d) in response to (c), capturing another user event associated with the other screen object.

44. The method of claim 1, further comprising:
(d) determining, with a second API, whether the first screen object has been acted upon by the user.
